(19) United States
(12) Patent Application Publication
(10) Pub. No.: US 2004/0143817 A1
(43) Pub. Date: Jul. 22, 2004

(54) Information managing apparatus

(76) Inventor: Tosiyasu L. Kunii, Tokyo (JP)

Correspondence Address: DOWELL & DOWELL, P.C., Suite 309, 1215 Jefferson Davis Highway, Arlington, VA, 22202, US

(21) Appl. No.: 10/423,895

(22) Filed: Apr. 28, 2003

(30) Foreign Application Priority Data
Jan. 17, 2003 (JP) 2003-010429

(51) Int. Cl. G06F 9/44

(52) U.S. Cl. 717/120; 717/116; 717/162

(57) ABSTRACT

A referring unit refers to two computer programs. An extracting unit specifies a correspondence relation between modules of the two programs, based on an equivalence relation selected by an equivalence relation selector. Based on the correspondence relation, a first acquiring unit specifies an attaching mapping and a second acquiring unit specifies an identification function. As a result of a series of processings, final information is recorded in a recorder.

### BACKGROUND OF THE INVENTION

1. Field of the Invention

The present invention relates to an information management technology, and more particularly to an information managing apparatus which maintains the integrity of data among a plurality of data structures, decides on interface to be employed and processes other various tasks.

2. Description of the Related Art

The architecture of information systems is shifting, with increasing speed, from one for use with a single large-scale site to one for use with multiple distributed large-scale sites, as typically seen, for example, in the integration system built as a result of the consolidation of major banks. However, the engineering model by which to fit into this architecture as a basic framework is missing in the current software engineering and reengineering technologies serving as fundamental technologies for the desired architecture. This is because the integration method is missing at the modeling level and thus engineers who are in charge of constructing each site have to devise each of the module groups in order to design and construct each site. Hence, the specifications for the module groups differ site by site. If such specifications for the module groups were disclosed among those involved in the construction of the module groups, its reconstruction might be possible. Otherwise, the number of reconstruction systems will increase exponentially due to the resulting combinations among all the modules, and the so-called “development manpower explosion” will occur. Besides, in the most of actual cases in this regard, the specifications of the module groups are not disclosed at all for the reason of strict secrecy policy in the corporations. In this case, although information regarding the preparation of the interface among the modules might be disclosed, the number of interface increases exponentially due to the combination among every interface, so that the “development manpower explosion” is likely to occur.

At home and abroad, the relational database (RDB) model, the entity relationship (ER) model, the XML by tags, the UML by graphs and so forth are being actively researched and applied, but these do not serve as a complete theoretical foundation that leads to a model by which to construct the large-scale distributed information systems. For example, the theoretical scheme has not reached to a stage in which the interface specifications between modules can be handled, in a unified manner, among different sites. Thus, the above-mentioned “development manpower explosion” cannot be solved.

It is no exaggeration to state that to ensure the inter-operability of the information systems is the most important social theme in our IT society today, where the inter-operability is the property in which the information can be processed freely and flexibly maintaining the consistency between different information systems. Affected also by the recent economical situations in every country, the integration or merger of corporations is on the steady increase, and much expectation for this theme grows these days. However, the conventional method allows for the order of n(log n) at best as the number of interface, and the number of interface may amount to the order of n to the exponential in the worst case.

### SUMMARY OF THE INVENTION

The present invention has been made in view of the foregoing circumstances and an object thereof is to provide an information managing technology that guarantees the above-mentioned inter-operability as a linear model.

An information managing apparatus, according to the present invention, comprises: a referring unit which refers to a plurality of data structures which are respectively topological spaces and which are handled as a disjoint union of the topological spaces; an extracting unit which extracts elements to be noted as a topological subspace of each of the plurality of data structures on the basis of a predetermined equivalence relation; a first acquiring unit which specifies an attaching mapping which mutually associates the extracted topological subspaces with the plurality of data structures in the topological spaces corresponding thereto; a second acquiring unit which specifies, based on the specified attaching mapping and the topological spaces respectively corresponding to the data structures, an identification function representing a correspondence from the topological spaces to an adjunction space defined by the specified attaching mapping; and a recorder which records the specified identification function, the specified attaching mapping and the adjunction space in an associated manner.

The “data structure” is an aggregate of data handled in an information system where the “information system” is an arbitrary system that manages, processes and performs other processings on information, by some means. Thus, the information system includes, for example, a site, computer program, database, arbitrary digitized management information such as data on management, finance and personnel matters.

In this information managing apparatus, interface for each element of the information system can be acquired by transforming it to an adjunction space model only once. Thus, the inter-operability is guaranteed by n times of the transformation for n elements, and the number of interface increases linearly. The adjunction space model is set up based on an identification space by an equivalence relation as a theoretical foundation, and an invariant can be defined among the information systems. Thus, a processing of information can be optimized and made objective based on this invariant. Hence, the above-mentioned problem is solved.

In this information managing apparatus, the above-described data structure may be a computer program, and a component that constitutes the data structure may be a module that constitutes the program. In addition to their usual meanings, the “program” and “module” are a concept that includes the whole functioning as an aggregate of data and the part thereof, such as a site and pages constituting the site.

Under such a circumstance, an equivalence relation storage may store an equivalence relation that classifies an equivalence class based on a substantial function of the module. For instance, if an equivalence relation which is “whether or not a module has a function of compressing input data” is set, a module having such the function can be extracted as an element that satisfies this equivalence class.

In this example, the number of equivalence classes is two. However, the number of equivalence classes may be, in general, a positive integer k. For example, a topological space, which is a program X, has a topological subspace X0 which is a data processing function. And if the equivalence relation has been prepared in terms of this “data processing function”, then it is, for instance, partitioned into the exclusive OR (disjoint union) of the following four equivalence classes:

x0: data compressing functions.

x1: data expansion functions.

x2: data transmitting functions.

x3: functions not belonging to the above equivalence classes x0, x1, and x2.

Now, these four equivalence classes become known for the program X, which is one of the two programs, whose correspondence relation is to be defined, and the following four equivalence classes for the other program Y are similarly determined as shown in the following equation.

f(Y₀)=␣ᵢf(yᵢ), where i=0 to 3.

Thus, four attaching mappings and four identification functions are also determined in this example.

Though the equivalence relations have been prepared based on the module functions here, those may be prepared based on the characteristics of the modules. As examples of the “characteristics”, there may be the length of module codes, the processing time of the module, an OS that the module depends on, the degree of module extendibility and so forth. These can be utilized when a plurality of programs are integrated so as to develop a generic program, or in order to grasp or have a better understanding of a correspondence of functions between the plurality of programs.

If a database serves as the data structure, the elements will be, for example, attributes described in the database. In such a case, if the topological subspace is “data of employees”, the equivalence relations may be determined in terms of the attributes characterizing the employees, such as “age”, “affiliated post” and “year of entrance” and so forth. However, in deciding the equivalence relations, it is desirable to store the equivalence relations that classify the equivalence classes based on substantial meanings and significance of the attributes, instead of based on the so-called tuple names in the attributes. For example, since it seems that the “affiliated post” and the “assigned division” are the same, an equivalence relation that treats these two as equal to each other shall be stored. A simple method to realize this may be such that “the affiliated post or assigned division is the business section” or the like is prepared as the equivalence relation.

If the data structure is a merchandise list, the elements will be merchandise. Then, it is preferable that the equivalence relation storage stores equivalence relations that classify the equivalence classes by directing attentions to a purchase behavior. For example, in an online bookstore Y, its site generally has a list Y0 of books for sale as a topological subspace. By the equivalence relation where the attentions are directed to the behavior of “purchasing”, Y0 is partitioned into the exclusive OR (disjoint union) of the following four equivalence classes:

y0: books being browsed now, purchase of which is under consideration.

y1: books, purchase of which is desired.

y2: books, purchase of which is decided.

y3: books not belonging to the above equivalence classes y0, y1 and y2.

A purchaser X also has four equivalence classes that correspond to the above equivalence classes and, similar to the case described before, four attaching mappings and four identification functions are determined in this case, too.

If the data structure is a corporate structure or an organization chart, the elements will be, for example, divisions that constitute an organization. Then, it is preferable that the equivalence relation storage stores the equivalence relations which classify equivalence classes based on substantial functions of the divisions. Thus, in a case where two companies are to be integrated, if the departments or divisions that have the substantially same functions or activities are specified and mutually associated and then stored in advance accordingly, the thus stored data can be utilized in making a policy on the integration of these two departments or divisions.

It is to be noted that expressions, used in the present invention, converted to or substituted between a method, a system, a recording medium, a computer program and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a structure of an information managing apparatus according to an embodiment of the present invention.

FIG. 2 shows an internal structure of an equivalence relation storage shown in FIG. 1.

FIG. 3 is a conceptual diagram showing how an attaching mapping is determined by the selection of an equivalence relation, according to an embodiment.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

First of all, a fundamental theory of Adjunction Space Model and Cellular Structured Space Model (hereinafter simply referred to also as Cellular Information Model (CIM)) proposed by the inventor of the present invention is described as basic technology on which the preferred embodiments are based and, thereafter, specific embodiments will be described. The cellular information model is a model in which the concept of cell dimensions is added to the adjunction space model.

[Basic Technology]

The cellular information model can be applied, as an information model, to the field of a random data model and is such that items in time and space are regarded as a form of a situation. Mathematically speaking, the cellular information model is based on a cellular spatial structure theory which is classified as a theoretical framework concerning homotopy and can be thought of as an extended theory of the graph theory.

[0] Prologue: What are Cyberworlds?

Cyberworlds are being formed on the web either intentionally or spontaneously, with or without design. Widespread and intensive local activities are melting each other on the web globally to create cyberworlds. What is called e-business including electronic financing has been conducted in cyberworlds and has gone beyond a national finance level in its scale. Without proper modeling, cyberworlds have continued to grow chaotic and are now out of human understanding and control. A novel information model we named “an adjunction space model” serves to globally integrate local models. As an information model, it is also applicable to the category of irregular data models that capture spatio-temporal aspects information worlds. Mathematically, it is based on cellular spatial structures in a homotopy theoretical framework.

[1] Set Theoretical Design

First of all, we start our design work of cyberworlds from defining a collection of objects we are looking at to construct them in cyberspaces. To be able to conduct automation on such collections by using computers as intelligent machines, each collection has to be a set because computers are built as set theoretical machines. Intuitively, a set X is a collection of all objects x having an identical property, say, P(x). Symbolically X={x|P(x)}. Any object in a set is called an element. A set without an element is named the empty set φ. A set is said to be open if all of its elements are interior. Given sets X and Y, computers perform set theoretical operations such as the union X∪Y, the intersection XΩY, the difference X−Y (also denoted as x\y), and the negation [symbol] X. Suppose we begin our cyberspace architecture design from a set X as the initial cyberspace. Given all elements u of an unknown cyberspace U, if they are confirmed to be the elements of our cyberspace X, the unknown cyberspace is called a subset of X or a subcyberspace of X and denoted as U⊂X. Thus, the subset check is automatically performed by processing (∀u (u∈U→u∈X). The closure \overline{U} of U is the intersection of all closed subsets of X, containing U. In other words, the closure \overline{U} is the elements of X that are not the exterior elements of U. The set of all the subsets of X, {U|U⊂X}, is called a power set of X and denoted as 2^{x}. It is also called the discrete topology of X. The discrete topology is quite useful to design the cyberspace as consisting of subcyberspaces.

[2] Topological Design

Now, we go into the business of designing the cyberspace as the union of the subcyberspaces of X and their overlaps. The cyberspace thus designed is generally called a topological space (X, T) where T⊂2^{x}. Designing a topological space is automated by the following specification:

1) X∈T and φ∈T;

2) For an arbitrary index set J,

$$∀ j ∈ J ( {U}_{j} ∈ T ) \to {⋃}_{j ∈ J} {U}_{j} ∈ T ;$$

3) U, V∈T→U∩V∈T.

T is said to be the topology of the topological space (X, T). Given two topologies T₁ and T₂ on X such that T₁⊂T₂, we say T₁ is weaker or smaller than T₂ (alternatively, we say that T₂ is stronger or larger than T₁; we also say T₂ is finer than T₁, or T₁ is coarser than T₂). Obviously the strongest topology is the discrete topology (the power set) and the weakest topology is φ. For simplicity, we often use X instead of (X, T) to represent a topological space whenever no ambiguity arises. When we see two topological spaces (X, T) and (Y, T′), how we can tell (X, T) and (Y, T′) are equivalent? Here is a criterion for us to use computers to automatically validate that they are topologically equivalent. Two topological spaces (X, T) and (Y, T′) are topologically equivalent (or homeomorphic) if there is a function f: (X, T)→(Y, T′) that is continuous, and its inverse exists and is continuous. We write (X, T)≅(Y, T′) for (X, T) to be homeomorphic to (Y, T′). Then, how to validate the continuity of a function f? It amounts to checking, first, ∀B∈T′, f^{←}(B)∈T, where f^{←}(B) means the inverse image of B by f, then, next, checking the following:

B is open [symbol] f⁻¹(B) is open in X.

[3] Functions

Given a function f: X→Y, there are a total function and a partial function. For f: X→Y if and only if ∀x∈X, ∃f(x), f is called a total function. A function f: X′→Y|X′⊃X is called a partial function, and not necessarily f(x) exists for every x∈X. For total functions, there are three basic types of relationships or mappings: there are three basic types of relationships or mappings:

1. Injective or into, meaning ∀x, y∈X, x≠y [symbol] f(x)≠f(y); alternatively, ∀x, y∈X, F(x)=F(y) [symbol] x=y;

2. Surjective or onto, meaning (∀y∈Y) (∃x∈X) [f(x)=y]; and

3. Bijective, meaning both injective and surjective.

[4] Equivalence Relations

For a binary relation R⊂X×X on a set X, R is : reflexive if (∀x∈X) [xRx]: reflexivity, symmetric if (∀x, y∈X) [xRy [symbol] yRx]: symmetry, and transitive if (∀x, y, z∈X) [[xRy [symbol] yRz] [symbol] xRz]: transitivity.

R is called an equivalence relation (denoted by ˜) if R is reflexive, symmetric and transitive.

Given x∈X, a subset of X defined by x\˜={y∈X: x˜y} is called the equivalence class of x. Here a class actually means a set; it is a tradition, and hard to be changed at this stage. The set of all the equivalence classes X/˜ is called the quotient space or the identification space of X.

X/˜={x/˜∈2^{X}|x∈X}⊂2^{X}.

From the transitivity, for each x∈X, x/˜≠φ, the followings hold:

x˜y< [symbol] x/˜=y/˜, and

x+y [symbol] x/˜∩y/˜=φ.

This means a set X is partitioned (also called decomposed) into non-empty and disjoint equivalence classes.

Let us look at some simple examples. In Euclidean geometry, given a set of figures, a congruence relation divides them into a disjoint union of the subsets of congruent figures as a quotient space; a similarity relation divides them into a disjoint union of the subsets of similar figures as a quotient space. Congruence and similarity relations are examples of affine transformations. A symmetry relation in group theory divides a set of figures into a disjoint union of the subsets of symmetric figures as a quotient space. In e-commerce, to be e-merchandise is an equivalence relation while e-trading is a poset (partially ordered) relation. In the e-trading, a seller-buyer relation is asymmetric while an e-merchandise relation is symmetric because e-merchandise for sellers is also e-merchandise for buyers.

[5] A Quotient Space (an Identification Space)

Let X be a topological space. Let f be a subjective (onto) and continuous mapping called a quotient map (often also called an identification map) that maps each point x∈X to a subset (an equivalence class x/˜∈X/˜) containing x

f: X→X/˜.

Here, as explained before, “a map f: X→Y is surjective (onto)” means

(∀y∈Y)(∃x∈X)[f(x)=y].

Suppose we take a surjective map f such that for subset X⁰ of X, X⁰⊂X,

X⁰ is open [symbol] f⁻¹(X⁰)|y∈A is open in X (this means f is continuous), X/˜ is called a quotient space (or an identification space) by a quotient map (or an identification map) f. There is a reason why a quotient space is also called an identification space. It is because, as stated before, a quotient space is obtained by identifying each element (an equivalence class) x/˜∈X/˜ with a point x∈X that is contained in x/˜.

[6] An Attaching Space (an Adjunction Space or an Adjoining Space)

Let us start with a topological space X and attach another topological space Y to it. Then,

Y_{f}=Y␣_{f}X=Y␣X/˜

is an attaching space (an adjunction space or an adjoining space) obtained by attaching (gluing, adjuncting, or adjoining) Y to X by an attaching map (an adjunction map or an adjoining map) f (or by identifying each point y∈Y₀|Y₀⊃Y with its image f(y)∈X by a continuous map f). ␣ denotes a disjoint union (another name is an “exclusive OR”) and often a + symbol is used instead.

Attaching map f is a continuous map such that

f: Y₀→X,

where Y₀⊂Y. Thus, the attaching space Y_{f}=Y␣X/˜ is a case of quotient spaces

Y␣X/˜=Y␣_{f}X=Y␣X/(x˜f(y)|∀y∈Y₀).

The identification map g in this case is

g: Y␣X→Y␣_{f}X=Y_{f}=(Y␣X−Y₀)␣Y₀.

Restriction and Inclusion

For any function g: Y→Z

the restriction of g to X (X→Y) is:

g|X=g∘i: X→Z

where i: X→Y is an inclusion, i.e., ∀x∈X, i(x)=x.

[7] Extensions and Retractions of Continuous Maps

For topological spaces X and Y, and a subspace A⊂X, a continuous map f: X→Y such that f|A: A→Y is called a continuous extension (or simply an extension) of a map f|A from A onto X.

A restriction r is a continuous extension of an identity map 1_{A}: A→A onto X such that

r: X→A.

Then, r|A=1_{A}.

For A⊂X, A is called a deformation retract of X, if there is a retraction

r: X→A such that i∘r˜1_{X}.

If A is a single point A={a}⊂X, A is called retractable.

[8] Homotopy

Homotopy is a case of extensions. Let X and Y be topological spaces, f, g: X→Y be continuous maps, and I=[1, 0]. Homotopy is defined

H: X×I→Y

where for t∈I

H=f when t=0, and

H=g when t=1.

Homotopy is an extension of continuous maps

H|X×{0}=fi₀, and

H|X×{1}=gi₁

where

i₀=X×{0}→X, and

i₁=X×{1}→X.

Topological spaces X and Y are homotopically equivalent X≅Y, namely of the same homotopy type, if the following condition is met:

For two functions f and h

f: X→Y and h: Y→X,

h ∘ f≅1_{X} and f ∘ h≅1_{Y},

where 1_{X} and 1_{Y} are identity maps

1_{X}: X→X and 1_{Y}: Y→Y.

Homotopy equivalence is more general than topology equivalence. Homotopy equivalence can identify a shape change that is topologically not any more equivalent after the change. While a shape element goes through deformation processes, the deformation processes are specified by a homotopy and validated by homotopy equivalence. As a matter of fact, from the viewpoint of the abstractness of invariance, homotopy equivalence is more abstract than set theoretical equivalence because, when we change a given set by adding or deleting elements, we can make the set homotopy equivalent by preserving the operation of add or delete and also the added or deleted elements.

[9] Cellular Structured Spaces (Cellular Spaces)

A cell is a topological space X that is topologically equivalent (homeomorphic) to an arbitrary dimensional (say, n-dimensional, where n is a natural number) closed ball Bⁿ called a closed n-cell. An open n-cell is denoted as IntBⁿ (also as Bⁿ and more often as eⁿ). Bⁿ is

Bⁿ={x∈Rⁿ|∥x∥≦1},

namely a closed n-dimensional ball, and Rⁿ is an n-dimensional real number.

IntBⁿ={x∈Rⁿ|∥x∥<1}

is an open n-dimensional ball and is an interior of Bⁿ.

∂Bⁿ=Bⁿ−Bⁿ=Sⁿ⁻¹

is the boundary of Bⁿ, and it is an (n−1)-dimensional sphere Sⁿ⁻¹.

For a topological space X, a characteristic map F is a continuous function.

F: Bⁿ→X

such that it is a homeomorphism:

F: Bⁿ→F(Bⁿ), and

F(∂Bⁿ)=F(Bⁿ)−F(Bⁿ)

eⁿ=F(Bⁿ) is an open n-cell, and −eⁿ=F(Bⁿ) is a closed n-cell.

From a topological space X, we can compose a finite or infinite sequence of cells X^{p} that are subspaces of X, indexed by integer Z, namely {X^{p}|×X^{p}⊂X, p∈Z} called a filtration, such that

X^{p} covers X (or X^{p} is a covering of X), namely,

$$X = {⋃}_{p ∈ Z} {X}^{p} ,$$

and X^{p} is a subspace of X^{p}, namely,

X⁰⊂X¹⊂x²⊂ . . . ⊂X^{p-1}⊂X^{p}⊂ . . . ⊂X.

(this is called a skeleton) The skeleton with a dimension at most p is called a p-skeleton.

We also say that {X^{p}|X^{p}⊂X, p∈Z} is a cell decomposition of a topological space X, or a partition of a topological space X into subspaces X^{p} which are closed cells. When we perform cell decomposition, by preserving cell attachment maps, we can turn cellular spaces into reusable resources. We name such preserved and shared information a cellular database and a system to manage it a cellular database management system (cellular DBMS).

To be more precise, given a topological space X, we inductively compose a filtration X^{p} with a skeleton

X⁰⊂X¹⊂X²⊂ . . . ⊂X^{p-1}⊂X^{p}⊂ . . . ⊂X

as a topological space as follows:

(1) X⁰⊂X is a subspace whose elements are 0-cells of X.

(2) X^{p} is composed from X^{p-1} by attaching (adjunctioning, adjoining, or gluing) to it a disjoint union □ᵢBᵢ^{p} of closed p-dimensional balls via a surjective and continuous mapping called an attaching map (an adjunction map, an adjoining map, or a gluing map)

F: □_{f}∂Bᵢ^{p}→X^{p-1.}

In other words, we compose X^{p} from X^{p-1} by taking a disjoint union X^{p-1}□(□ᵢBᵢ^{p}) and by identifying each point x in ∂Bᵢ^{p}, x∈∂Bᵢ^{p}, with its image F(x) by a continuous mapping

Fᵢ=F|∂Bᵢ^{p}:∂Bᵢ^{p}→X^{p-1}

such that x˜fᵢ(x) for each index i. Thus, X^{p} is a quotient space (the identification space)

$$\begin{matrix}{X}^{p} = {X}^{p - 1} ⊔ ( {⊔}_{i} {B}_{i}^{p} ) \vert ( x ∼ {F}_{i} ( x ) \vert ∀ x ∈ \partial {B}_{i}^{p} ) \\ = {X}^{p - 1} {⊔}_{F} ( {⊔}_{i} {B}_{i}^{p} )\end{matrix}$$

and is a case of attaching spaces (adjunction spaces or adjoining spaces). The map Fᵢ is a case of attaching maps (adjunction maps, adjoining maps or gluing maps) of a cell Bᵢ^{p}. A filtration space is a space homotopically equivalent to a filtration.

We thus obtain a map F as a case of identification maps

F: X^{p-1}␣(␣ᵢBᵢ^{p})→X^{p-1}␣_{F}(␣ᵢBᵢ^{p})=X^{p}

A characteristic map F for each n-cell Bᵢ^{p}=F(Bᵢ^{p})∈X^{p is}

Fᵢ=F|∂Bᵢ^{p}:∂Bᵢ^{p}→X^{p-1}.

The embedding of X^{p-1} as a closed subspace of X^{p} is

F|X^{p-1}=X^{p-1}→X^{p}.

We need to address on some related important subjects. There are important cellular spaces in applications. They include CW-complexes and manifolds. If a filtration space is finite, it is equivalent to a CW-space. Further, if a CW-space is diffeomorphic, it is equivalent to a manifold space.

[10] Design and Implementation

There are great many issues on the design and implementation of the cellular model.

Cell attachment is designed into two-layer table (a table is a Cartesian product) generation. The first layer is generated as identifier tables, and the second as the instance tables. There is also a problem of designing cell boundaries. One design is as pointers. For example, any point on the boundary ∂Bᵢ¹ is realized as a pointer to a point of a line Bᵢ¹. Further, an element mapping specifies a pointer. Of course, tables can represent boundaries explicitly and are useful in cellular database design. An internal diagram can also represent an element mapping. However, since an internal diagram includes the points themselves, it alone cannot be used for the boundary representation; hence, an internal diagram has to be combined with a pointer representation.

[Preferred Embodiments Based on the Basic Technology]

In an information managing apparatus described hereinbelow, interface for each element of the information system can be acquired by transforming it to an adjunction space model only once. Thus, the inter-operability is guaranteed by n times of the transformation for n elements, and the number of interface increases linearly. The adjunction space model is set up based on an identification space by an equivalence relation as a theoretical foundation, and an invariant can be defined among information systems. Thus, a processing of information can be optimized and made objective based on this invariant. When proceeding from an adjunction space to a cellular structured space model, this information managing apparatus can treat a cellular structured space, having different dimensions, as an adjunction space model, so that different types of information can be integrated. This is one of the reasons why the inter-operability can be guaranteed.

The equivalence relation is not taken into account in the relational model scheme. Thus, the information can not be dealt with in the unified way. Another different table indicating relations among tables may be provided in such a manner as to attach a patch to the tables so as to pass through the interface, but this way the number of interface will increase exponentially.

On the other hand, SAP, UML (Unified Modeling Language) and so forth based on the ER (Entity Relation) models are models in the graph theory, and the equivalence relations are not included in these models, so that the similar type of problems are caused. These are the status quo of the infrastructure information system. However, the information managing apparatus described hereinbelow solves this problem.

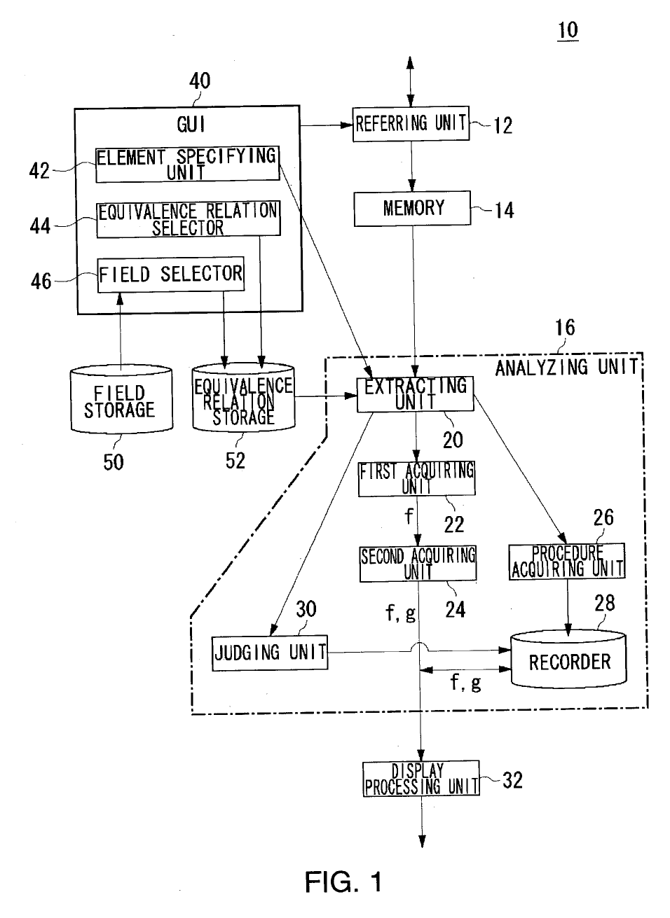

FIG. 1 shows a structure of an information managing apparatus 10. A referring unit 12 refers to various data structure entities in a variety of information systems. In what is to follow in the present embodiment, suppose that a single data structure entity (hereinafter also referred to simply as data structure) is referred to from each of two information systems, and a predetermined correspondence or interface is defined between them. The data structure entity thus referred to (hereinafter also called “target data”) or an ID indicating target data or the like is temporarily stored in a memory 14. Now, if two target data are referred to, these data respectively correspond to topological spaces X and Y and, at this instance, an exclusive OR (disjoint union)

X␣Y

of these topological spaces are determined. It is to be noted that a topological space here is a space such that a subspace thereof can be defined.

An analyzing unit 16 includes an extracting unit 20, a first acquiring unit 22, a second acquiring unit 24, a procedure acquiring unit 26, a judging unit 30 and a recorder 28. A GUI (Graphical User Interface) 40 includes an element specifying unit 42, an equivalence relation selector 44 and a field selector 46. The GUI 40 is provided with a keyboard, mouse or the like as hardware, and, as software, contains various programs that communicate user's instructions to the information managing apparatus 10. However, the degree of freedom as to which structure or structures is or are to be built into the analyzing unit 16 or GUI 40 is high. For instance, the combined three units alone that consist of the extracting unit 20, first acquiring unit 22 and second acquiring unit 24 can achieve the function of the analyzing unit 16. Which structure or structures to be implemented depends on the objective of a design. The GUI 40 performs a processing on a field storage 50 and an equivalence relation storage 52, and operates on the extracting unit 20.

As a general function, the GUI 40 transmits a user's instruction to the referring unit 12 and specifies target data. The element specifying unit 42 acquires from a user an instruction as to which element is to be processed among the target data, and conveys this to the extracting unit 20. The field selector 46 refers to the data stored in the field storage 50, and identifies the field to which the target data belong, according to a user's selection instruction. The fields of the target data are concretely recorded in the field storage 50, where the fields include “program developing area”, “database managing area”, and so forth. Suppose now that the user uses the information managing apparatus 10 in developing programs, then the “program developing area” is selected by the field selector 46. A selection result will be sent to the equivalence relation storage 52.

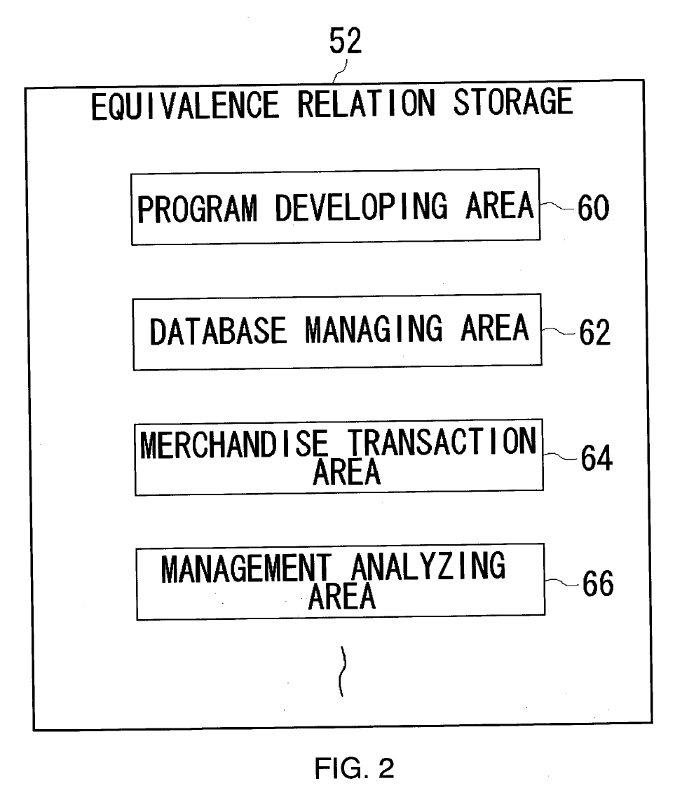

FIG. 2 shows an internal structure of the equivalence relation storage 52. The equivalence relation storage 52 holds, in advance, many equivalence relations which may be classified as a program developing area 60, a database managing area 62, a merchandise transaction area 64, a management analyzing area 66 and so forth. If the “program developing area” is selected, the program developing area 60 is selected by a switch (not shown) provided inside the equivalence relation storage 52. In the program developing area 60, described therein are equivalence relations that the user can utilize in his/her “program development”. Though actual examples of the equivalence relations will be described later, the user specifies an equivalence relation that the user would like to actually utilize, by the equivalence relation selector 44. The thus specified equivalence relation (hereinafter referred to also as intended equivalence relation) is conveyed to the extracting unit 20.

The extracting unit 20 extracts an element whose correspondence relation is to be defined in two target data (hereinafter referred to also as target element), based on the intended equivalence relation. At this time, the user specifies one of the target elements by the element specifying unit 42, and the extracting unit 20 extracts a corresponding target element from the other of the target data, based on the intended equivalence relation. The target elements, which have been thus proved to correspond to the target data, form a topological subspace, that is, an equivalence class, and no element of this equivalence class is common to those of other equivalence classes as theoretically guaranteed by the adjunction space model. Since the equivalence classes are classified by an invariant specified by the equivalence relation, the target data can be objectively classified. Thus, the individual difference in operators is not reflected on the results of the classification, thus achieving a system of high utility. Moreover, when one of the target elements is determined, the other of the target elements is also determined, so that the number of correspondence relation or interface is linear. In this manner, the inter-operability is assured and, therefore, the problems in the conventional practice are solved.

As will be shown later using an example, once the intended equivalence relation is decided, how the target elements correspond to each other and in what meaning is uniquely determined. Thus, the first acquiring unit 22 can specify an attaching mapping that indicates the correspondence between the target elements. If an attaching mapping f is determined, an adjunction space is determined as Y␣_{f}X=Y␣X/˜. The adjunction space is a topological space equipped with a correspondence relation, via the attaching mapping f, between topological spaces X and Y that have primarily no intersection therebetween.

An identification function g is a mapping from a space of a mere exclusive OR of the topological spaces X and Y, to an adjunction space determined by an attaching function f. Thus, when the adjunction space is decided, the second acquiring unit 24 specifies the identification function g. In actuality, the identification function g can be described based on its definition, by the topological spaces. X and Y and the attaching function f. Referring to FIG. 1, the attaching mapping f obtained by the first acquiring unit 22 is sent to the second acquiring unit 24, the attaching function f and the identification function g are outputted from the second acquiring unit 24 and are then recorded in the recorder 28. This completes a main processing where the two target data are associated with each other. The processing results or information stored already in the recorder 28 are reshaped or displayed via a display processing unit 32 as necessary, so as to be utilized by the users.

The procedure acquiring unit 26 acquires a series of procedures in the extracting unit 20, namely, acquires the target elements and intended equivalence relations that the user specified at the outset (the series of procedures will be referred to also as “marked procedure” hereinafter), and associates the marked procedures with

topological spaces X and Y;

intended equivalence relation;

attaching mapping f; and

identification function g

specified by the series of procedures, as a homotopy, so as to be recorded in the recorder 28. The topological spaces X and Y, the intended equivalence relation, the attaching mapping f and the identification function g which are obtained collectively as a processing result will be referred to also as “final information” hereinbelow.

The judging unit 30 detects the marked procedure in the extracting unit 20 when the user carries out a new processing. And if the marked processing is already recorded in the recorder 28, the judging unit 30 reads out final information corresponding thereto from the recorder 28, and sends the thus read-out final information to the display processing unit 32. Thereby, processing otherwise performed by the first acquiring unit 22 and the second acquiring unit 24 can be skipped.

Concrete processing operations by the above-described structure will be described here. Suppose now that the user grasps and records correspondence relations between modules by analyzing the relation between two programs developed separately. However, the program mentioned here may be sites and the module may be a page or pages constituting the sites. When the multiple distributed large-scale sites are designed as mentioned above, the information managing apparatus according to the present embodiment becomes very useful for integrating portions having an equivalent function among these sites and for designing the interface therefor. The terms “program” and “module” in the present embodiment include such cases.

The user first specifies, by the GUI 40, two computer programs whose correspondence relation is to be analyzed. The referring unit 12 accesses an external program storage (not shown) in accordance with the user's instruction, so as to acquire the specified programs. Thereafter, the user specifies a module of interest in one of the two programs by the element specifying unit 42. This module is conveyed to the extracting unit 20.

Almost at the same time when the programs are specified as above, the user also selects a field which is now to be analyzed, by the field selector 46. Here, suppose that the “program developing area” is selected. Then, the program developing area 60 corresponding to this selection becomes active in the equivalence relation storage 52, and equivalence relations contained in the program developing area 60 can be selected. The user then selects a desired equivalence relation, that is, intended equivalence relation, by the equivalence relation selector 44.

Now, suppose that the user selected an equivalence relation by directing his/her attentions to a function of the program. Then, the equivalence relation may be one which derives two equivalence classes as mentioned above, such as “the module having a function of addition and multiplication operation”, or one which derives three or more equivalence classes. In any case, a great many of equivalence relations related to the functions that the users are expected to give attentions to in the course of developing or analyzing programs are prepared and stored, in advance, in the program developing area 60.

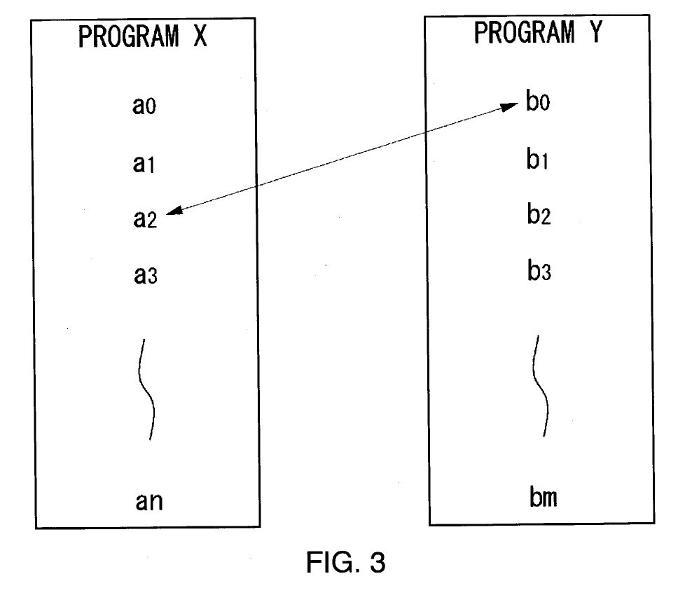

FIG. 3 is a conceptual diagram in which an attaching mapping f is specified, between modules of the two programs, by an equivalence relation included in the program developing area 60. Here, a module a2 of the program X is corresponded to a module b0 of the program Y between the programs X and Y in such a manner that the module a2 and the module b0 have the same functions. Thus, the attaching mapping f acquired by the first acquiring unit 22 is the correspondence relation a2→b0.

An identification function g is acquired by the second acquiring unit 24, and the final information is recorded in the recorder 28 as programs X and Y, intended equivalence relation, attaching function f and identification function g. Based on this final information, the user can perform a program analysis. If there are n modules in one program, the correspondence relation with any of modules in the other program is specified for each of the n modules. Thus, the number of interface grows linearly and the problem of the manpower blowup is solved.

In the above description, a scheme for specifying the correspondence relation between programs has been described. If the “database managing area” is selected as a field, instead, one element (or one attribute) in a database can be related, corresponded or associated to another element (or another attribute) in any of a plurality of databases. In such a case, if being substantially the same attribute is set as an equivalence relation, then information on the same attribute can always be shared and available among a plurality of databases. The integration of attributes is possible as a join operation in the relational database. But, once the join operation is carried out, a plurality of original attributes can no longer be restored, so that the data will not be reusable. However, by employing the information managing apparatus 10 according to the present embodiment, a plurality of attributes can be kept as they are, and at the same time the attributes can be classified into and corresponded to the respective equivalence classes in a given set by using the invariant defined as “the same function”, so that the usability of data is significantly improved.

If the “merchandise transaction area” is selected as another field, the correspondence can be made between two merchandise lists, for example. If one of the two merchandise lists is a list of those who sell merchandise while the other a list of those who buy merchandise and if “the same merchandise” is selected as an intended equivalence relation, then merchandise for which a buyer side and a seller side are capable of being matched instantaneously can be specified. Moreover, if “1000 yen or below” is selected as an intended equivalence relation, whether sale can be made or not can even be specified. In other words, suppose that a buyer side sets up a condition “purchase if 1000 yen or below”, then sale is made if a seller side sells the merchandise at 1000 yen or less. Since there exists an attaching mapping f for the sale that can be made, it suffices that merchandise whose sale is possible is notified to the buyer side and the seller side according to this mapping. The information managing apparatus 10 may include a notifying unit, which notifies the user accordingly if there exists an attaching mapping f. Since various other conditions may be considered in the actual transaction, “color”, “place of production”, “size”, “weight” and so forth, for example, are preferably prepared in advance.

In a case when the “management analyzing area” is selected as still another field so as to plan the reorganization of a company, organization charts consisting of two divisions X and Y, for example, are referred to. As for one of the organization charts, an element, that is, a department or a section in the division X, is specified from the element specifying unit 42. Then the attributes such as “size”, “revenue status”, “substantial function”, “location” and so forth are selected as equivalence relations. As a result, departments or sections in the division Y which are equivalent to those in the division X in terms of these attributes emerge from the other of the divisions, that is, the division Y, thus contributing to supporting a policy making of the reorganization.

The present invention has been described based on the embodiments which are only exemplary. It is understood by those skilled in the art that there exist other various modifications and such modifications are also encompassed by the scope of the present invention.

As an example, an equivalence relation registering unit which registers a new equivalence relation in the equivalence relation storage 52 may be further provided in the information managing apparatus 10 according to the present embodiments. Similarly, a field registration unit which registers a new field in the field storage 50 may be further provided in the information managing apparatus 10. In that case, the user may register the equivalence relation for each of the fields, by the equivalence relation registering unit.

Although the present invention has been described by way of exemplary embodiments, it should be understood that many changes and substitutions may further be made by those skilled in the art without departing from the scope of the present invention which is defined by the appended claims.

What is claimed is:

1. An information managing apparatus, comprising:
a referring unit which refers to a plurality of data structures which are respectively topological spaces and which are handled as a disjoint union of the topological spaces;
an extracting unit which extracts elements to be noted as a topological subspace of each of the plurality of data structures on the basis of a predetermined equivalence relation;
a first acquiring unit which specifies an attaching mapping which mutually associates the extracted topological subspaces with the plurality of data structures in the topological spaces corresponding thereto;
a second acquiring unit which specifies, based on the specified attaching mapping and the topological spaces respectively corresponding to the data structures, an identification function representing a correspondence from the topological spaces to an adjunction space defined by the specified attaching mapping; and
a recorder which records the specified identification function, the specified attaching mapping and the adjunction space, in an associated manner.

2. The apparatus of claim 1, further comprising:
an equivalence relation storage which stores in advance a plurality of equivalence relations applied to the data structures; and
an equivalence relation selector which allows a user to select one of the equivalence relations.

3. The apparatus of claim 2, wherein the data structure is a computer program and wherein the element is a module of the program.

4. The apparatus of claim 3, wherein the equivalence relation storage stores equivalence relations which classify equivalence classes based on a substantial function of the program.

5. The apparatus of claim 3, wherein the equivalence relation storage stores equivalence relations which classify equivalence classes based on a characteristic of the program.

6. The apparatus of claim 2, wherein the data structure is a database and wherein the element is an attribute employed in the database.

7. The apparatus of claim 6, wherein the equivalence relation storage stores equivalence relations which classify equivalence classes based on a substantial meaning of the attribute.

8. The apparatus of claim 2, wherein the data structure is a list of merchandises and wherein the element is a merchandise.

9. The apparatus of claim 8, wherein the equivalence relation storage stores equivalence relations which classify equivalence classes based on a purchase behavior on the merchandise.

10. The apparatus of claim 2, wherein the data structure is a corporate structure and wherein the element is a section constituting the corporate.

11. The apparatus of claim 10, wherein the equivalence relation storage stores equivalence relations which classify equivalence classes based on a substantial function of the section.

12. The apparatus of claim 1, further comprising a procedure acquiring unit which acquires, as a homotopy, a procedure to specify the attaching mapping.

13. The apparatus of claim 12, further comprising a judging unit which judges whether a homotopy as to an acquisition procedure of an attaching mapping to be newly specified has already been acquired or not.

14. The apparatus of claim 1, further comprising:
a field storage which prepares a plurality of fields to which the data structures belong;
a field selector which selects one of the prepared fields; and
an equivalence relation storage which prepares equivalence relations classified according to the fields,
wherein the equivalence relation storage provides an equivalence relation which corresponds to the field selected by the field selector.

15. An information managing apparatus, including:
an analyzing unit which defines, based on an adjunction space model, relations between a plurality of data structures, with emphasis on an invariant among the data structures.
